(19) United States
(12) Patent Application Publication
(10) Pub. No.: US 2022/0321497 A1
(43) Pub. Date: Oct. 6, 2022

(54) COMMUNICATION DEVICE, COMMUNICATION METHOD, AND NON-TRANSITORY COMPUTER-READABLE RECORDING MEDIUM

(71) Applicant: WOVEN PLANET HOLDINGS, INC., Tokyo (JP)

(72) Inventor: Toshinobu WATANABE, Tokyo-to (JP)

(73) Assignee: WOVEN PLANET HOLDINGS, INC., Tokyo (JP)

(21) Appl. No.: 17/712,213

(22) Filed: Apr. 4, 2022

(30) Foreign Application Priority Data
Apr. 6, 2021 (JP) 2021-064861

(51) Int. Cl. H04L 47/80; H04L 47/12

(52) U.S. Cl. CPC H04L 47/805; H04L 47/12

(57) ABSTRACT

A communication device is installed on a moving body and capable of communicating with an external device via a plurality of communication lines. The communication device includes a controller. The controller acquires a plurality of streaming data to be transmitted to the external device and dynamically controls an allocation relationship between the plurality of streaming data and the plurality of communication lines. The plurality of communication lines include a first communication line and a second communication line having a lower priority than the first communication line. The controller dynamically controls the allocation relationship based on a first communication rate being a communication rate of the first communication line while preferentially allocating the plurality of streaming data to the first communication line in preference to the second communication line.

### CROSS-REFERENCE TO RELATED APPLICATION

This application claims priority to Japanese Patent Application No. 2021-064861 filed on Apr. 6, 2021, the entire contents of which are incorporated by reference herein.

### BACKGROUND

### Technical Field

The present disclosure relates to a communication technique applied to a moving body.

### Background Art

Patent Literature 1 discloses an in-vehicle communication device. The in-vehicle communication device supports both a mobile communication method and a WiFi communication method. When an abnormality of the vehicle is detected, the in-vehicle communication device transmits numerical data and image data indicating a vehicle travel status to a specified server. At this time, the in-vehicle communication device transmits the numerical data by the mobile communication method and transmits the image data by the WiFi communication method.

Patent Literature 2 discloses a method of performing a communication between communication devices provided in a vehicle. A wire communication is used for communication data having a high priority while a wireless communication is used for communication data having a low priority.

Patent Literature 3 discloses a communication line switching method in a communication terminal device which is connectable to a plurality of communication networks. One of the plurality of communication networks is selected based on an application priority. Then, a communication line to a transmission destination is formed through the one communication network selected.

### LIST OF RELATED ART

Patent Literature 1: Japanese Laid-Open Patent Application Publication No. JP-2018-120443
Patent Literature 2: Japanese Laid-Open Patent Application Publication No. JP-2017-158056
Patent Literature 3: International Publication WO2007/099700

### SUMMARY

It is conceivable that communications of a variety of streaming data are performed when a moving body such as a vehicle and a robot communicates with an external device. When a plurality of streaming data are simultaneously transmitted through a single communication line and a communication rate of the single communication line is decreased, qualities of the plurality of streaming data may be deteriorated uniformly. In view of the above, it is conceivable to simultaneously transmit the plurality of streaming data through a plurality of communication lines, respectively. However, increase in the number of communication lines used simultaneously causes increase in a communication cost accordingly. A technique that can flexibly perform a streaming data communication according to a situation is desired.

An object of the present disclosure is to provide a technique capable of achieving a flexible streaming data communication according to a situation in a moving body.

A first aspect is directed to a communication device that is installed on a moving body and capable of communicating with an external device via a plurality of communication lines.

The communication device includes a controller. The controller acquires a plurality of streaming data to be transmitted to the external device and dynamically controls an allocation relationship between the plurality of streaming data and the plurality of communication lines.

The plurality of communication lines include: a first communication line; and a second communication line having a lower priority than the first communication line.

The controller dynamically controls the allocation relationship based on a first communication rate being a communication rate of the first communication line while preferentially allocating the plurality of streaming data to the first communication line in preference to the second communication line.

A second aspect is directed to a communication method from a moving body to an external device.

The moving body is capable of communicating with the external device via a plurality of communication lines.

The Communication Method Includes:

a process of acquiring a plurality of streaming data to be transmitted to the external device; and

a dynamic allocation control process that dynamically controls an allocation relationship between the plurality of streaming data and the plurality of communication lines.

The plurality of communication lines include: a first communication line; and

a second communication line having a lower priority than the first communication line.

The dynamic allocation control process dynamically controls the allocation relationship based on a first communication rate being a communication rate of the first communication line while preferentially allocating the plurality of streaming data to the first communication line in preference to the second communication line.

A third aspect is directed to a communication program applied to a communication device installed on a moving body.

The moving body is capable of communicating with an external device via a plurality of communication lines.

The communication program, when executed by a computer, causes the computer to execute:

a process of acquiring a plurality of streaming data to be transmitted to the external device; and

a dynamic allocation control process that dynamically controls an allocation relationship between the plurality of streaming data and the plurality of communication lines.

The plurality of communication lines include: a first communication line; and a second communication line having a lower priority than the first communication line.

The dynamic allocation control process dynamically controls the allocation relationship based on a first communication rate being a communication rate of the first communication line while preferentially allocating the plurality of streaming data to the first communication line in preference to the second communication line.

According to the present disclosure, the moving body is capable of using the plurality of communication lines. The plurality of communication lines include the first communication line having a higher priority and the second communication line having a lower priority. Basically, the plurality of streaming data are preferentially allocated to the first communication line having the higher priority. In a situation where the second communication line is unnecessary, the number of communication lines is reduced and thus the communication cost also is reduced. In addition, the allocation relationship between the plurality of streaming data and the plurality of communication lines is dynamically controlled according to the first communication rate of the first communication line. Thus, a flexible streaming data communication according to a situation (i.e., the first communication rate of the first communication line) becomes possible.

### BRIEF DESCRIPTION OF DRAWINGS

FIG. 1 is a conceptual diagram showing an outline of a communication system according to an embodiment of the present disclosure;

FIG. 2 is a conceptual diagram for explaining an application example of a communication system according to an embodiment of the present disclosure;

FIG. 3 is a block diagram showing a configuration example of a communication system according to an embodiment of the present disclosure;

FIG. 4 is a block diagram showing a concrete example of a communication system according to an embodiment of the present disclosure;

FIG. 5 is flow chart showing a streaming communication process by a communication device according to an embodiment of the present disclosure:

FIG. 6 is a timing chart for explaining a first example of a dynamic allocation control process according to an embodiment of the present disclosure;

FIG. 7 is another timing chart for explaining the first example of the dynamic allocation control process according to an embodiment of the present disclosure;

FIG. 8 is a timing chart for explaining a second example of the dynamic allocation control process according to an embodiment of the present disclosure;

FIG. 9 is another timing chart for explaining the second example of the dynamic allocation control process according to an embodiment of the present disclosure;

FIG. 10 is a timing chart for explaining a third example of the dynamic allocation control process according to an embodiment of the present disclosure; and

FIG. 11 is another timing chart for explaining the third example of the dynamic allocation control process according to an embodiment of the present disclosure.

### EMBODIMENTS

Embodiments of the present disclosure will be described with reference to the accompanying drawings.

### 1. Outline of Communication System

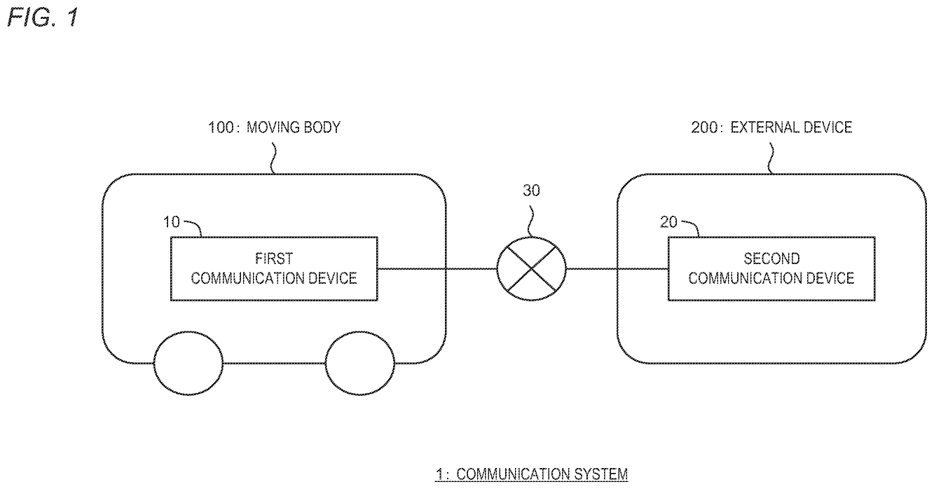

FIG. 1 is a conceptual diagram showing an outline of a communication system 1 according to the present embodiment. The communication system 1 includes a first communication device 10, a second communication device 20, and a communication network 30. The first communication device 10 and the second communication device 20 are connected to each other via the communication network 30. The first communication device 10 and the second communication device 20 is able to communicate with each other via the communication network 30.

In the present embodiment, at least one of the first communication device 10 and the second communication device 20 is installed on a moving body. Examples of the moving body include a vehicle, a robot, a flying object, and the like. The vehicle may be an automated driving vehicle or a vehicle driven by a driver. Examples of the robot include a logistics robot, a work robot, and the like. Examples of the flying object include an airplane, a drone, and the like.

In the following description, the first communication device 10 is installed on a moving body 100. The second communication device 20 is installed on an external device 200 outside the moving body 100. A type of the external device 200 is not limited in particular. For example, the external device 200 is a management server for managing the moving body 100. As another example, the external device 200 may be a remote support device that remotely supports an operation of the moving body 100. As yet another example, the external device 200 may be a moving body different from the moving body 100. Typically, the first communication device 10 of the moving body 100 and the second communication device 20 of the external device 200 performs a wireless communication. However, the present embodiment is not limited to the wireless communication.

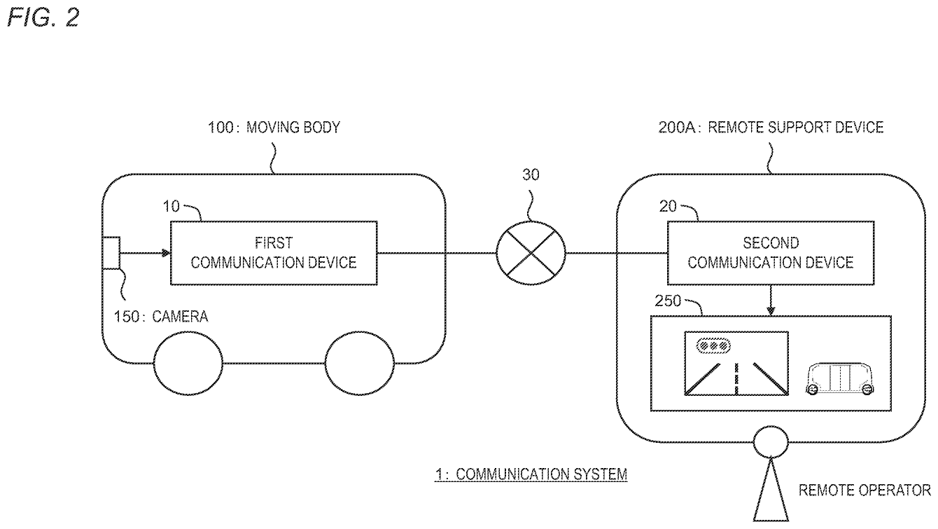

FIG. 2 is a conceptual diagram for explaining an application example of the communication system 1 according to the present embodiment. In the example shown in FIG. 2, the communication system 1 is utilized for “remote support” that remotely supports an operation of the moving body 100. More specifically, a camera 150 is installed on the moving body 100. The camera 150 images a situation around the moving body 100 to acquire image information. The first communication device 10 transmits the image information to a remote support device 200A being an example of the external device 200. The second communication device 20 of the remote support device 200A receives the image information from the moving body 100. The remote support device 200A displays the received image information on a monitor 250. A remote operator looks at the image information displayed on the monitor 250 to grasp the situation around the moving body 100 and remotely support the operation of the moving body 100. Examples of the remote support by the remote operator include recognition support, judgement support, remote driving, and the like. An instruction from the remote operator is transmitted from the second communication device 20 to the first communication device 10 of the moving body 100. The moving body 100 operates according to the instruction from the remote operator.

A variety of streaming data may be transmitted from the moving body 100 to the external device 200. For example, in the case of the remote support shown in FIG. 2, streaming data of the image (video) captured by the camera 150 are transmitted. In addition, audio streaming data acquired by a microphone installed on the moving body 100 may be transmitted. When the camera 150 includes a front camera and a rear camera, streaming data of the forward image and streaming data of the rear image may be transmitted separately.

Hereinafter, a case where a plurality of streaming data (multiple types streaming data) are simultaneously transmitted from the moving body 100 to the external device 200 is considered. There may be a priority for each of the plurality streaming data. For convenience, the priority of streaming data is hereinafter referred to as a “streaming priority.” For example, in the case of the remote support described above, the streaming priority is set from a viewpoint of ensuring remote support accuracy. For example, the streaming priority of the video streaming data is higher than the streaming priority of the audio streaming data. As another example, the streaming priority of the forward image streaming data is higher than the streaming priority of the rear image streaming data.

When the plurality of streaming data are simultaneously transmitted through a single communication line and a communication rate of the single communication line is decreased, qualities of the plurality of streaming data may be deteriorated uniformly. Such the uniform deterioration in data quality regardless of the streaming priority is undesirable in terms of use of the streaming data. For example, in the case where the remote support is performed by using video and audio, the uniform deterioration in data qualities of the video and the audio having different streaming priorities is not preferable in terms of remote support accuracy.

The first communication device 10 of the moving body 100 according to present embodiment is configured to be capable of communicating with the external device 200 via a plurality of communication lines. Since the number of communication lines that can be used simultaneously is increased, it becomes easy to ensure the communication rate as a whole, that is, the data quality as a whole. The first communication device 10 transmits the plurality of streaming data to the external device 200 by using a necessary number of communication lines among the plurality of communication lines.

However, the increase in the number of communication lines used simultaneously causes increase in a communication cost accordingly. It is therefore desirable to flexibly perform the streaming data communication according to a situation. The first communication device 10 according to the present embodiment is configured to be capable of “dynamically” controlling an allocation relationship between the plurality of streaming data and the plurality of communication lines.

Hereinafter, the communication system 1 according to the present embodiment will be described in more details.

### 2. Configuration Example of Communication System

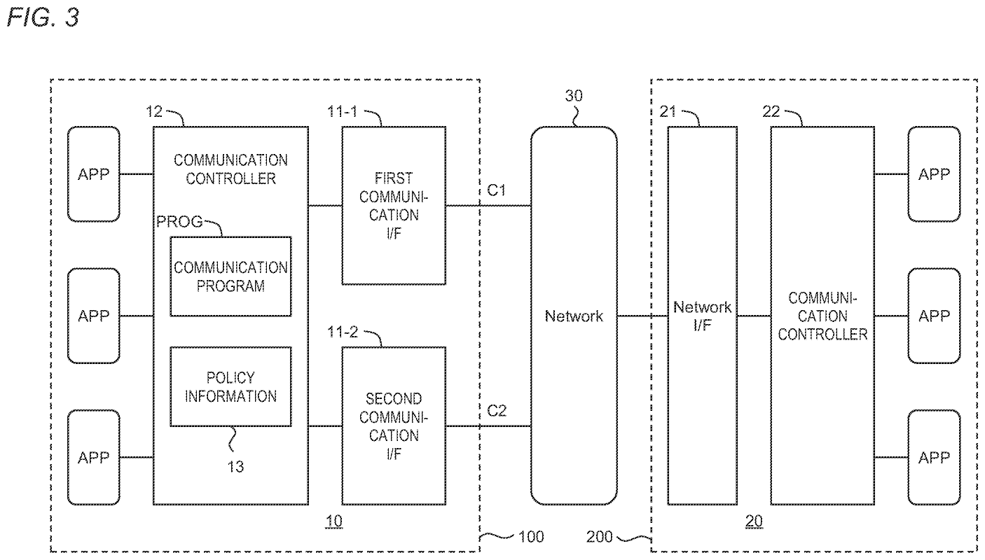

FIG. 3 is a block diagram showing a configuration example of the communication system 1 according to the present embodiment.

The first communication device 10 supports multiple types of communication methods (communication systems, communication protocols). Examples of the communication method include a common cellular method provided by MNO (Mobile Network Operator), an inexpensive cellular method provided by MVNO (Mobile Virtual Network Operator), a wireless LAN (Local Area Network) method, and the like. A communication cost differs among the multiple types of communication methods. In the example above, the wireless LAN method is the lowest and the common cellular method is the highest.

As shown in FIG. 3, the first communication device 10 includes a plurality of communication interfaces 11 and a communication controller 12.

The plurality of communication interfaces 11 are connected to the communication network 30 and perform communications with the second communication device 20 based on the multiple types of communication methods, respectively. For example, a first communication interface 11-1 performs a communication based on a first communication method. A second communication interface 11-2 performs a communication based on a second communication method different from the first communication method. It should be noted that the plurality of communication interfaces 11 may be realized by different physical interfaces, or may be realized by a combination of a common physical interface and different logical interfaces.

The plurality of communication lines are established based on the multiple types of communication methods, respectively. That is, the plurality of communication lines are associated with the multiple types of communication methods, respectively. It can also be said that the plurality of communication lines are associated with the plurality of communication interfaces 11, respectively. The plurality of communication interfaces 11 communicate with the second communication device 20 via the plurality of communication lines, respectively. For example, the first communication interface 11-1 performs the communication via a first communication line C1 based on the first communication method. The second communication interface 11-2 performs the communication via a second communication line C2 based on the second communication method.

The communication controller 12 is provided to control data transmitted and received by at least one application running on the moving body 100. For example, the communication controller 12 acquires the plurality of streaming data transmitted from at least one application to the external device 200 (i.e., the second communication device 20). The communication controller 12 allocates the plurality of streaming data to one or more of the plurality of communication interfaces 11 to be used. In other words, the communication controller 12 allocates the plurality of streaming data to one or more of the plurality of communication lines to be used. Then, the communication controller 12 transmits each of the plurality of streaming data to the external device 200 via the allocated communication interface 11 (i.e., the allocated communication line).

Moreover, the communication controller 12 performs “congestion control” that reduces a quality of the streaming data, as necessary. For example, in the case of the image (video) streaming data, the congestion control reduces its quality by lowering a resolution or a frame rate. As another example, the congestion control may reduce the quality of the streaming data by changing a compression rate.

The communication controller 12 is realized, for example, by a cooperation of a computer and a computer program. The moving body 100 is provided with a computer including a processor and a memory. The computer program that provides the functions of the communication controller 12 is hereinafter referred to as a “communication program PROG.” The communication program PROG is stored in the memory. The functions of the communication controller 12 are realized by the processor (the computer) executing the communication program PROG. It should be noted that the communication program PROG may be recorded on a non-transitory computer-readable recording medium. The communication program PROG may be provided via a network.

The second communication device 20 includes a network interface 21 and a communication controller 22. The network interface 21 is connected to the communication network 30 and communicates with the first communication device 10.

The communication controller 22 is provided to control data transmitted and received by at least one application running on the external device 200. For example, the communication controller 22 receives via the network interface 21 the plurality of streaming data transmitted from the first communication device 10. Then, the communication controller 22 outputs the plurality of streaming data each to a destination application.

The communication controller 22 is realized, for example, by a cooperation of a computer and a computer program. The external device 200 is provided with a computer including a processor and a memory. The computer program is stored in the memory. The functions of the communication controller 22 are realized by the processor (the computer) executing the computer program.

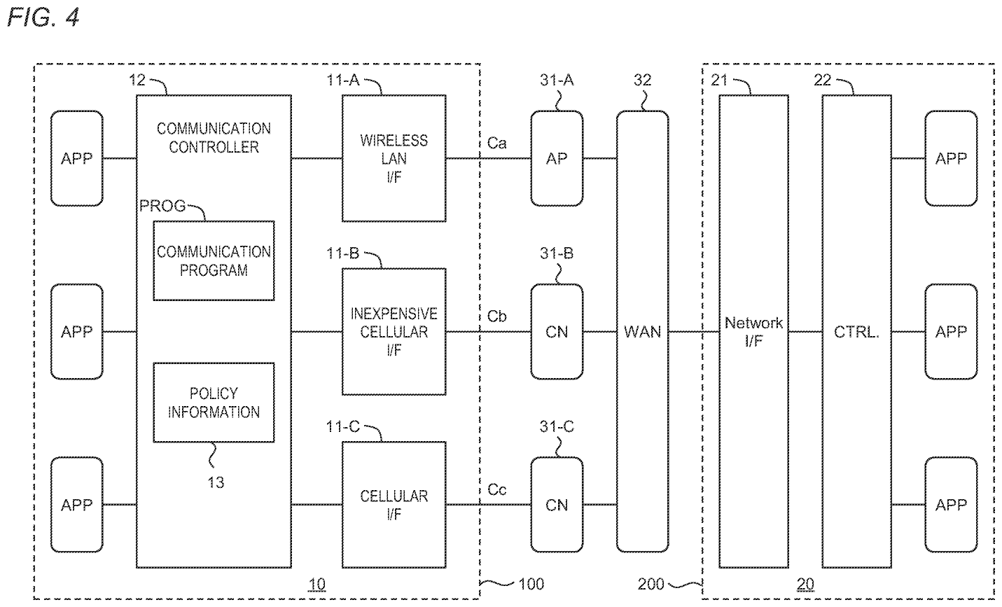

FIG. 4 is a block diagram showing a concrete example of the communication system 1 according to the present embodiment.

The plurality of communication interfaces 11 of the first communication device 10 include a wireless LAN interface 11-A, an inexpensive cellular interface 11-B, and a cellular interface 11-C. The wireless LAN interface 11-A performs a communication via a communication line Ca based on a wireless LAN method (system). The wireless LAN interface 11-A is connected to a communication network 32 (e.g., a WAN) via an access point 31-A. The inexpensive cellular interface 11-B performs a communication via a communication line Cb based on an inexpensive cellular method (system). The inexpensive cellular interface 11-B is connected to the communication network 32 via a cellular network 31-B. The cellular interface 11-C performs a communication via a communication line Cc based on a common cellular method (system). The cellular interface 11-C is connected to the communication network 32 via a cellular network 31-C.

In the case of the example shown in FIG. 4, the communication cost is lower in an order of the communication line Ca based on the wireless LAN method, the communication line Cb based on the inexpensive cellular method, and the communication line Cc based on the common cellular method.

### 3. Streaming Communication Process

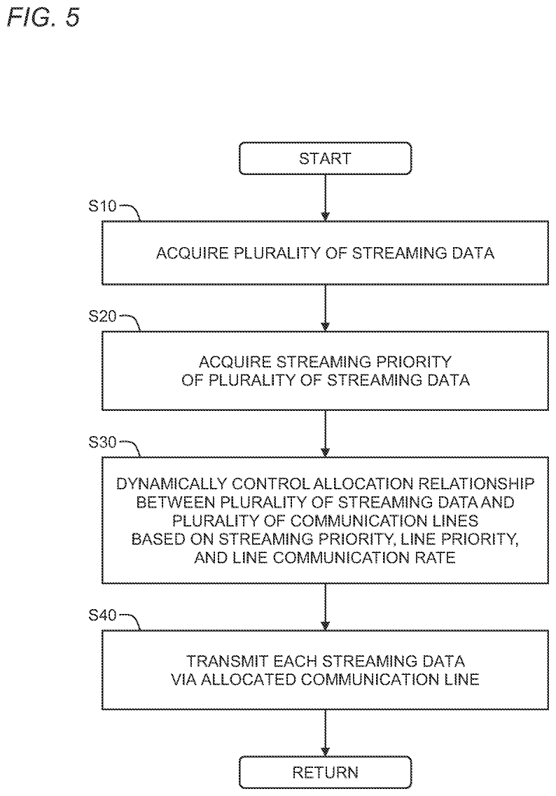

FIG. 5 is a flow chart showing a streaming communication process by the first communication device 10 according to the present embodiment.

### 3-1. Step S10 (Streaming Data Acquisition Process)

In Step S10, the communication controller 12 acquires a plurality of streaming data transmitted from at least one application to the external device 200 (i.e., the second communication device 20).

### 3-2. Step S20 (Streaming Priority Acquisition Process)

In Step S20, the communication controller 12 acquires the streaming priority of the plurality of streaming data. For example, in the case of the remote support described above, the streaming priority is determined from a viewpoint of ensuring remote support accuracy. For example, the streaming priority of the video streaming data is higher than the streaming priority of the audio streaming data. As another example, the streaming priority of the forward image streaming data is higher than the streaming priority of the rear image streaming data. It should be noted that the forward direction is a travel direction of the moving body 100 and the rear direction is a direction opposite to the travel direction. Therefore, when the travel direction of the moving body 100 is switched, the forward image and the rear image also are switched.

For example, the application stores identification information indicating a type of the streaming data in a header of the streaming data to be output. In this case, the communication controller 12 identifies the type of each streaming data based on the identification information included in the streaming data received from the application. Then, the communication controller 12 determines the streaming priority of the plurality of streaming data based on the type of each streaming data. Information indicating a correspondence relationship between the type of streaming data and the streaming priority is stored in advance in a memory device accessible by the communication controller 12.

As another example, the application may store information indicating a priority level of the streaming data in a header of the streaming data to be output. The priority level is set in multiple stages. The priority level may be quantified. The communication controller 12 identifies the priority level of each streaming data based on the priority level information included in the streaming data received from the application. Then, the communication controller 12 determines the streaming priority of the plurality of streaming data by comparing the priority levels of the plurality of streaming data.

As yet another example, when a single application outputs the plurality of streaming data, the single application may directly specify the streaming priority. In this case, the single application provides the communication controller 12 with information specifying the streaming priority. The communication controller 12 identifies the streaming priority of the plurality of streaming data based on the specified priority information.

### 3-3. Step S30 (Dynamic Allocation Control Process)

In Step S30, the communication controller 12 allocates the plurality of streaming data to one or more of the plurality of communication interfaces 11 to be used. In other words, the communication controller 12 allocates the plurality of streaming data to one or more of the plurality of communication lines to be used. Here, the communication controller 12 dynamically controls an allocation relationship between the plurality of streaming data and the plurality of communication lines according to a situation. This process is hereinafter referred to as a “dynamic allocation control process.”

More specifically, the communication controller 12 performs the dynamic allocation control process based on the streaming priority, a line priority, and a line communication rate. The streaming priority is acquired in the above-described Step S20.

The line priority is a priority of each of the plurality of communication lines. For example, the line priority is preset based on the communication cost. In this case, the line priority becomes higher as the communication cost becomes lower. That is, when the communication cost of the first communication line C1 is lower than the communication cost of the second communication line C2, the line priority of the first communication line C1 is set to be higher than the line priority of the second communication line C2 (i.e., C1>C2). In the case of the example shown in FIG. 4, the communication cost is lower in the order of the communication line Ca based on the wireless LAN method, the communication line Cb based on the inexpensive cellular method, and the communication line Cc based on the common cellular method. Accordingly, the line priority is higher in the order of the communication lines Ca, Cb, and Cc (i.e., Ca>Cb>Cc).

As another example, the line priority may be set from a viewpoint of reliability. In this case, the line priority becomes higher as the reliability becomes higher. As yet another example, the line priority may be set from a viewpoint of a theoretical value of a communication rate. In this case, the line priority becomes higher as the theoretical value of the communication rate becomes higher.

The line priority is preset by an administrator or a user of the communication system 1. The line priority may be switchable as necessary. Setting information of the line priority is stored in advance in a memory device accessible by the communication controller 12. The communication controller 12 acquires the line priority from the setting information.

The line communication rate is, for example, a throughput. As the line communication rate, an actual measured value may be used or an estimate value may be used. The line communication rate may be estimated by an estimation model having parameters such as a region, a time, a day of the week, and the like. The estimation model may be created through deep learning. Various methods of measuring or estimating the line communication rate have been proposed. In the present embodiment, the method is not limited in particular.

Policy information 13 (see FIGS. 3 and 4) indicates a policy of setting the allocation relationship between the plurality of streaming data and the plurality of communication lines. More specifically, the policy information 13 indicates a policy of setting the allocation relationship according to the streaming priority, the line priority, and the line communication rate. Such the policy information 13 is stored in advance in a memory device accessible by the communication controller 12. The communication controller 12 performs the dynamic allocation control process based on the policy information 13. Concrete examples of the dynamic allocation control process will be described later.

### 3-4. Step S40 (Streaming Data Transmission Process)

In Step S40, the communication controller 12 transmits each of the plurality of streaming data to the external device 200 via the allocated communication line (i.e., the allocated communication interface 11).

### 4. EXAMPLES OF DYNAMIC ALLOCATION CONTROL PROCESS

Hereinafter, some examples of the dynamic allocation control process according to the present embodiment will be described. In the examples described below, the configuration shown in FIG. 3, that is, the case where the number of available communication lines is 2 is considered. The same applies to a case where the number of available communication lines is 3 or more.

The first communication interface 11-1 performs the communication via the first communication line C1 based on the first communication method. The second communication interface 11-2 performs the communication via the second communication line C2 based on the second communication method. It is assumed that the line priority of the first communication line C1 is higher than the line priority of the second communication line C2 (i.e., C1>C2). For example, the communication cost of the first communication line C1 is lower than the communication cost of the second communication line C2.

Two types of streaming data, first streaming data S1 and second streaming data S2 are transmitted simultaneously. It is assumed that the streaming priority of the first streaming data S1 is higher than the streaming priority of the second streaming data S2 (i.e., S 1>S2).

A first communication rate R1 is a communication rate of the first communication line C1. A second communication rate R2 is a communication rate of the second communication line C2. Here, the communication rate is, for example, a throughput.

The communication controller 12 performs the dynamic allocation control process based on the streaming priority, the line priority, and the first communication rate R1 of the first communication line C1. If necessary, the second communication rate R2 of the second communication line C2 also is taken into consideration.

### 4-1. First Example

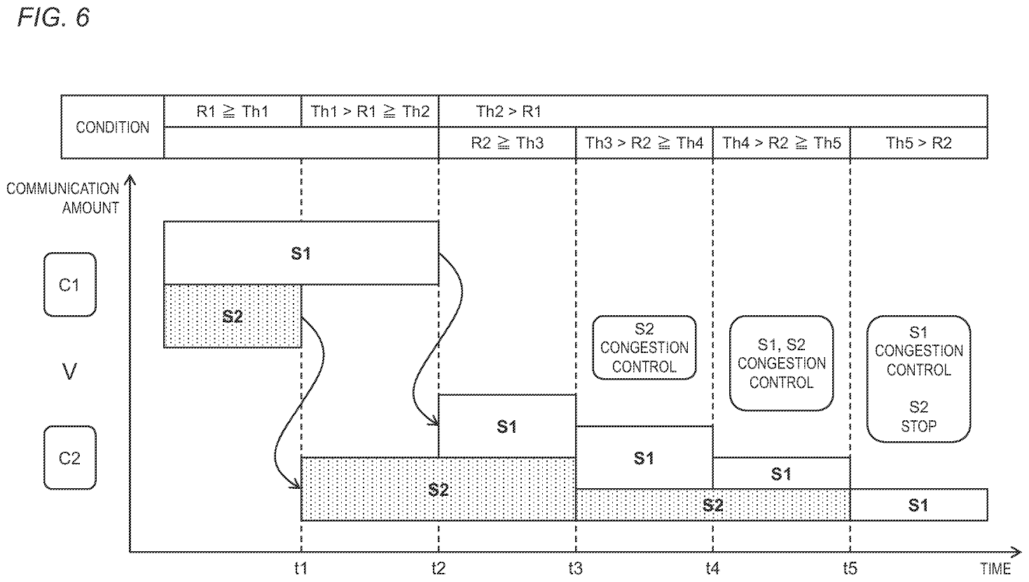

FIG. 6 is a timing chart for explaining a first example of the dynamic allocation control process. In the first example, the dynamic allocation control process intended to secure the data quality as much as possible will be described. That is, a communication requirement in the first example is “data quality-oriented.”

In a period before a time t1, the first communication rate R1 of the first communication line C1 is equal to or higher than a first threshold Th1. In this case, both the first streaming data S1 and the second streaming data S2 can be transmitted via the first communication line C1 without reducing the data quality. Therefore, the communication controller 12 allocates both the first streaming data S1 and the second streaming data S2 to the first communication line C1 having the higher line priority. The congestion control is not performed for the first streaming data S1 and the second streaming data S2. Therefore, an excellent data quality is secured.

In the period before the time t1, the second communication line C2 is not used. The second communication line C2 that is not used may be set to a hot standby state. Since the number of communication lines used simultaneously is minimized, the communication cost also is reduced. When the communication cost of the first communication line C1 is lower than the communication cost of the second communication line C2, the communication cost is particularly reduced. As described above, it is possible not only to secure the excellent data quality but also to reduce the communication cost.

In a period from the time t1 to a time t2, the first communication rate R1 of the first communication line C1 is lower than the first threshold Th1 and is equal to or higher than a second threshold Th2. In this case, the communication controller 12 allocates the first streaming data S1 having the higher streaming priority to the first communication line C1 having the higher line priority. On the other hand, the communication controller 12 allocates the second streaming data S2 having the lower streaming priority to the second communication line C2 having the lower line priority. Since the number of communication lines used is increased, the communication rate as a whole is secured and thus an excellent data quality is secured.

In a period after the time t2, the first communication rate R1 of the first communication line C1 is lower than the second threshold Th2. In this case, the communication controller 12 allocates both the first streaming data S1 and the second streaming data S2 to the second communication line C2. The first communication line C1 is not used. The first communication line C1 that is not used may be set to a hot standby state. Since the number of communication lines used simultaneously is minimized, the communication cost is reduced.

In a period from the time t2 to a time t3, the second communication rate R2 of the second communication line C2 is equal to or higher than a third threshold Th3. In this case, both the first streaming data S1 and the second streaming data S2 can be transmitted via the second communication line C2 without reducing the data quality. Therefore, the communication controller 12 does not perform the congestion control for the first streaming data S1 and the second streaming data S2. Thus, an excellent data quality is secured.

In a period from the time 13 to a time t4, the second communication rate R2 of the second communication line C2 is lower than the third threshold Th3 and is equal to or higher than a fourth threshold Th4. In this case, the communication controller 12 performs the congestion control for the second streaming data S2 having the lower streaming priority to reduce the quality of the second streaming data S2. On the other hand, the communication controller 12 does not perform the congestion control for the first streaming data S1 having the higher streaming priority. Therefore, an excellent data quality is secured with regard to the first streaming data S1 having the higher streaming priority.

In a period from the time t4 to a time t5, the second communication rate R2 of the second communication line C2 is lower than the fourth threshold Th4 and is equal to or higher than a fifth threshold Th5. In this case, the communication controller 12 performs the congestion control for the first streaming data S1 and the second streaming data S2. As a result, the qualities of the first streaming data S1 and the second streaming data S2 are reduced.

In a period after the time t5, the second communication rate R2 of the second communication line C2 is lower than the fifth threshold Th5. In this case, the communication controller 12 stops transmitting the second streaming data S2 having the lower streaming priority. At least the first streaming data S1 having the higher streaming priority are transmitted.

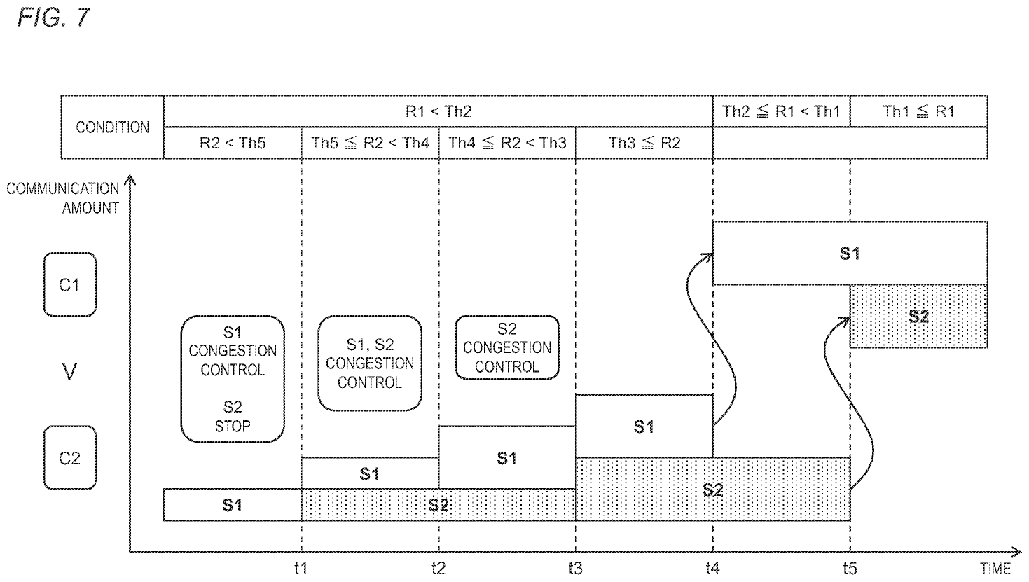

FIG. 7 shows a case where the line communication rate increases with time. The content of the dynamic allocation control process is similar to that in the case of FIG. 6.

As described above, basically, the first streaming data S1 and the second streaming data S2 are preferentially allocated to the first communication line C1 having the higher line priority. In the situation where the second communication line C2 is unnecessary, the number of communication lines is reduced and thus the communication cost also is reduced. In addition, the first streaming data S1 having the higher streaming priority is more preferentially allocated to the first communication line C1, as compared with the second streaming data S2. However, the allocation relationship between the streaming data S1, S2 and the communication lines C1, C2 is dynamically controlled according to the first communication rate R1 of the first communication line C1. Thus, a flexible streaming data communication according to a situation (i.e., the first communication rate R1 of the first communication line C1) becomes possible.

In the first example, the dynamic allocation control process is performed such that the congestion control is suppressed as much as possible even when the first communication rate R1 of the first communication line C1 decreases. More specifically, when the first communication rate R1 of the first communication line C1 decreases, the second communication line C2 is used appropriately without easily performing the congestion control. This makes it possible to secure the excellent data quality as much as possible. That is, the communication requirement of “data quality-oriented” is satisfied.

In addition, when the congestion control is necessary, the congestion control is preferentially performed for the second streaming data S2 having the lower streaming priority. As a result, the quality of the first streaming data S1 having the higher streaming priority is secured in preference to the second streaming data S2.

### 4-2. Second Example

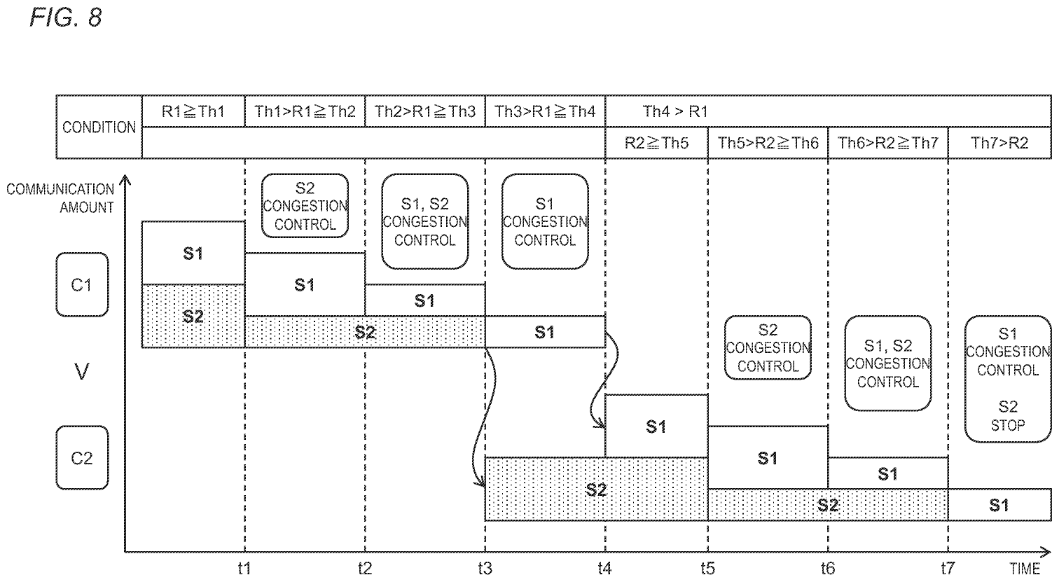

FIG. 8 is a timing chart for explaining a second example of the dynamic allocation control process. In the second example, the dynamic allocation control process intended to reduce the communication cost as much as possible will be described. That is, the communication requirement in the second example is “communication cost-oriented.”

In a period before a time t1, the first communication rate R1 of the first communication line C1 is equal to or higher than a first threshold Th1. In this case, the communication controller 12 allocates both the first streaming data S1 and the second streaming data S2 to the first communication line C1, as in the case of the first example described above. It is thus possible not only to secure the excellent data quality but also to reduce the communication cost.

In a period from the time t1 to a time t2, the first communication rate R1 of the first communication line C1 is lower than the first threshold Th1 and is equal to or higher than a second threshold Th2. In this case, the communication controller 12 keeps allocating both the first streaming data S1 and the second streaming data S2 to the first communication line C1 without using the second communication line C2. However, the communication controller 12 performs the congestion control for the second streaming data S2 having the lower streaming priority to reduce the quality of the second streaming data S2. On the other hand, the communication controller 12 does not perform the congestion control for the first streaming data S1. Therefore, an excellent data quality is secured with regard to the first streaming data S1 having the higher streaming priority.

In a period from the time t2 to a time t3, the first communication rate R1 of the first communication line C1 is lower than the second threshold Th2, and is equal to or higher than a third threshold Th3. In this case, the communication controller 12 performs the congestion control for the first streaming data S1 and the second streaming data S2. As a result, the qualities of the first streaming data S1 and the second streaming data S2 are reduced.

In a period from the time t3 to a time t4, the first communication rate R1 of the first communication line C1 is lower than the third threshold Th3 and is equal to or higher than a fourth threshold Th4. In this case, the communication controller 12 allocates the first streaming data S1 having the higher streaming priority to the first communication line C1 having the higher line priority. However, the congestion control is performed for the first streaming data S1. On the other hand, the communication controller 12 allocates the second streaming data S2 having the lower streaming priority to the second communication line C2 having the lower line priority. The congestion control is not performed for the second streaming data S2.

In a period after the time t4, the first communication rate R1 of the first communication line C1 is lower than the fourth threshold Th4. In this case, the communication controller 12 allocates both the first streaming data S1 and the second streaming data S2 to the second communication line C2. The first communication line C1 is not used.

In a period from the time t4 to a time t5, the second communication rate R2 of the second communication line C2 is equal to or higher than a fifth threshold Th5. In this case, both the first streaming data S1 and the second streaming data S2 can be transmitted via the second communication line C2 without reducing the data quality. Therefore, the communication controller 12 does not perform the congestion control for the first streaming data S1 and the second streaming data S2. Thus, an excellent data quality is secured.

In a period from the time t5 to a time t6, the second communication rate R2 of the second communication line C2 is lower than the fifth threshold Th5 and is equal to or higher a the sixth threshold Th6. In this case, the communication controller 12 performs the congestion control for the second streaming data S2 having the lower streaming priority to reduce the quality of the second streaming data S2. On the other hand, the communication controller 12 does not perform the congestion control for the first streaming data S1. Therefore, an excellent data quality is secured with regard to the first streaming data S1 having the higher streaming priority.

In a period from the time t6 to a time t7, the second communication rate R2 of the second communication line C2 is lower than the sixth threshold Th6 and is equal to or higher than a seventh threshold Th7. In this case, the communication controller 12 performs the congestion control for the first streaming data S1 and the second streaming data S2. As a result, the qualities of the first streaming data S1 and the second streaming data S2 are reduced.

In a period after the time t7, the second communication rate R2 of the second communication line C2 is lower than the seventh threshold Th7. In this case, the communication controller 12 stops transmitting the second streaming data S2 having the lower streaming priority. At least the first streaming data S1 having the higher streaming priority are transmitted.

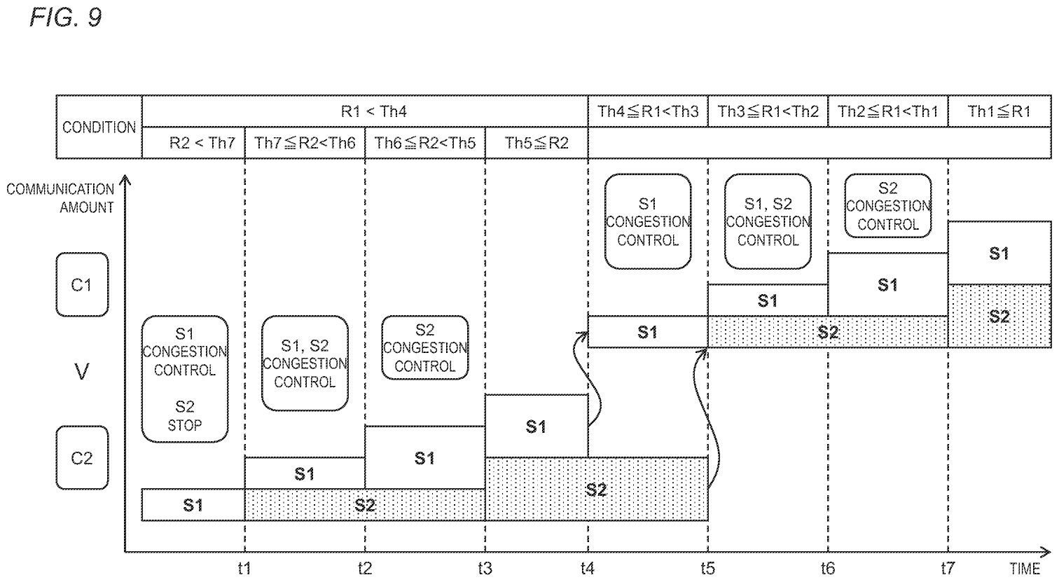

FIG. 9 shows a case where the line communication rate increases with time. The content of the dynamic allocation control process is similar to that in the case of FIG. 8.

As described above, in the second example, the dynamic allocation control process is performed such that the number of communication lines used simultaneously is suppressed as much as possible even when the first communication rate R1 of the first communication line C1 decreases. More specifically, the congestion control is appropriately performed instead of using the second communication line C2, until the first communication rate R1 of the first communication line C1 decreases to some extent. Since the number of communication lines used simultaneously is reduced, the communication cost is reduced. That is, the communication requirement of “communication cost-oriented” is satisfied.

In addition, when the congestion control is necessary, the congestion control is preferentially performed for the second streaming data S2 having the lower streaming priority. As a result, the quality of the first streaming data S1 having the higher streaming priority is secured in preference to the second streaming data S2.

### 4-3. Third Example

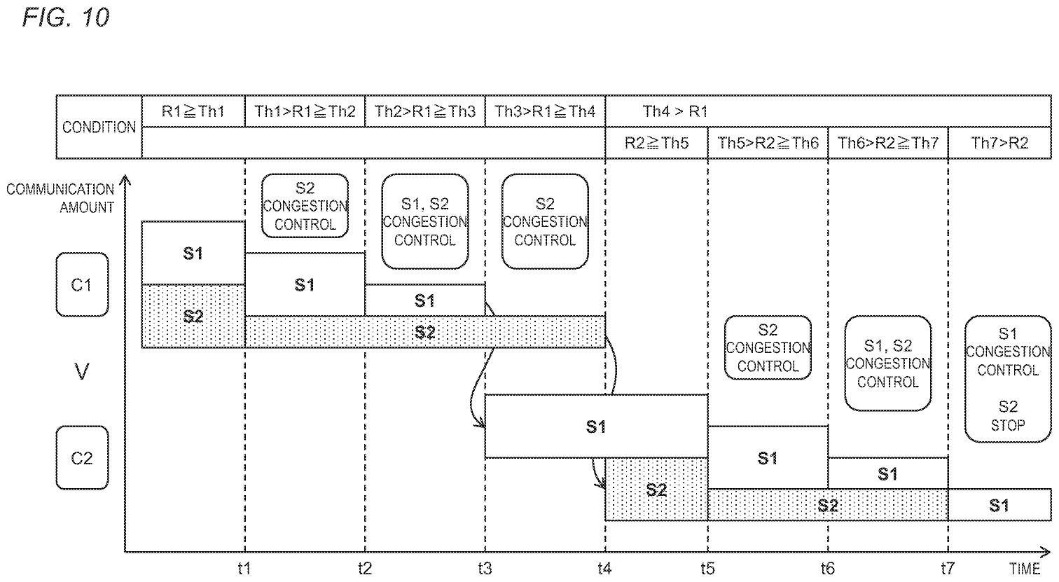

FIG. 10 is a timing chart for explaining a third example of the dynamic allocation control process. The third example is a modification of the second example. A description overlapping the case of the second example will be omitted as appropriate.

In the period from the time 13 to the time t4, the first communication rate R1 of the first communication line C1 is lower than the third threshold Th3 and is equal to or higher than the fourth threshold Th4. In this case, the communication controller 12 allocates the second streaming data S2 to the first communication line C1, and performs the congestion control for the second streaming data S2. On the other hand, the communication controller 12 allocates the first streaming data S1 to the second communication line C2. The congestion control is not performed for the first streaming data S1. As a result, the quality of the first streaming data S1 having the higher streaming priority is secured in preference to the second streaming data S2.

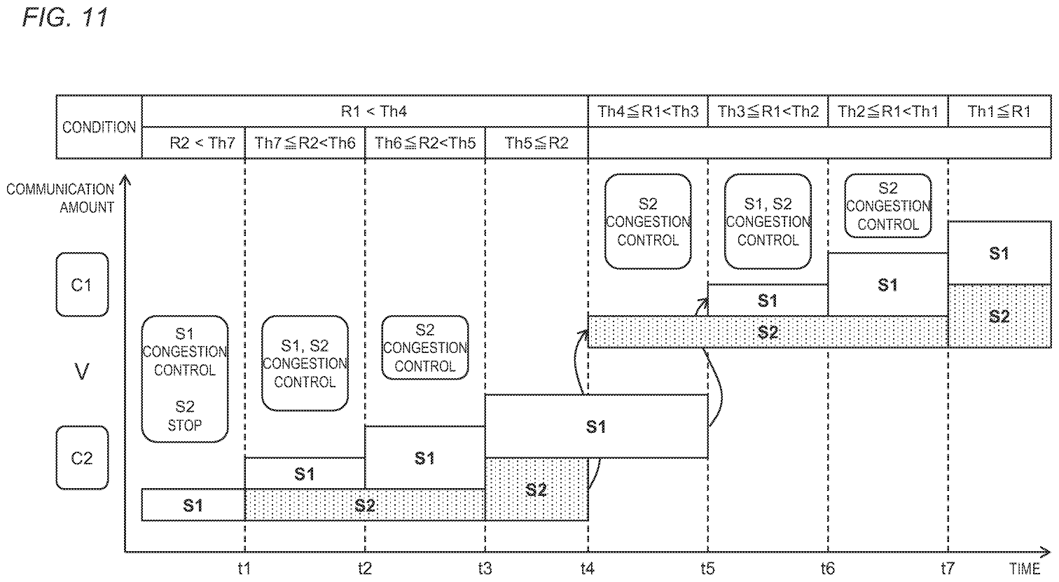

FIG. 11 shows a case where the line communication rate increases with time. The content of the dynamic allocation control process is similar to that in the case of FIG. 10.

### 5. Summary

According to the present embodiment, as described above, the moving body 100 is capable of using the plurality of communication lines. The plurality of communication lines include the first communication line C1 having the higher line priority and the second communication line C2 having the lower line priority. Basically, the plurality of streaming data are preferentially allocated to the first communication line C1 having the higher line priority. In the situation where the second communication line C2 is unnecessary, the number of communication lines is reduced and thus the communication cost also is reduced. However, the allocation relationship between the plurality of streaming data and the plurality of communication lines is dynamically controlled according to the first communication rate R1 of the first communication line C1. Thus, the flexible streaming data communication according to a situation (i.e., the first communication rate R1 of the first communication line C1) becomes possible.

In the first example described above, the dynamic allocation control process is performed such that the congestion control is suppressed as much as possible even when the first communication rate R1 of the first communication line C1 decreases. More specifically, when the first communication rate R1 of the first communication line C1 decreases, the second communication line C2 is used appropriately without easily performing the congestion control. This makes it possible to secure the excellent data quality as much as possible. That is, the communication requirement of “data quality-oriented” is satisfied.

In the second and third examples described above, the dynamic allocation control process is performed such that the number of communication lines used simultaneously is suppressed as much as possible even when the first communication rate R1 of the first communication line C1 decreases. More specifically, the congestion control is appropriately performed instead of using the second communication line C2, until the first communication rate R1 of the first communication line C1 decreases to some extent. Since the number of communication lines used simultaneously is reduced, the communication cost is reduced. That is, the communication requirement of “communication cost-oriented” is satisfied.

As described above, according to the present embodiment, the flexile streaming data communication according to the communication requirement also is possible.

What is claimed is:

1. A communication device that is installed on a moving body and capable of communicating with an external device via a plurality of communication lines,
the communication device comprising a controller configured to acquire a plurality of streaming data to be transmitted to the external device and to dynamically control an allocation relationship between the plurality of streaming data and the plurality of communication lines, wherein
the plurality of communication lines include:
a first communication line; and
a second communication line having a lower priority than the first communication line, and
the controller is further configured to dynamically control the allocation relationship based on a first communication rate being a communication rate of the first communication line while preferentially allocating the plurality of streaming data to the first communication line in preference to the second communication line.

2. The communication device according to claim 1, wherein
the plurality of streaming data include:
first streaming data; and
second streaming data having a lower priority than the first streaming data, and
the controller is further configured to preferentially allocate the first streaming data than the second streaming data to the first communication line, or to preferentially secure quality of the first streaming data than quality of the second streaming data.

3. The communication device according to claim 2, wherein
the controller is further configured to:
when the first communication rate of the first communication line is equal to or higher than a first threshold, allocate both the first streaming data and the second streaming data to the first communication line;
when the first communication rate of the first communication line is lower than the first threshold and is equal to or higher than a second threshold, allocate the first streaming data to the first communication line and allocate the second streaming data to the second communication line; and
when the first communication rate of the first communication line is lower than the second threshold, allocate both the first streaming data and the second streaming data to the second communication line.

4. The communication device according to claim 3, wherein
when the first communication rate of the first communication line is lower than the second threshold, the controller is further configured to control qualities of the first streaming data and the second streaming data based on a second communication rate being a communication rate of the second communication line.

5. The communication device according to claim 4, wherein
the controller is further configured to:
when the second communication rate of the second communication line is equal to or higher than a third threshold, not perform congestion control for the first streaming data and the second streaming data;
when the second communication rate of the second communication line is lower than the third threshold and is equal to or higher than a fourth threshold, perform the congestion control for the second streaming data without performing the congestion control for the first streaming data; and
when the second communication rate of the second communication line is lower than the fourth threshold and is equal to or higher than a fifth threshold, perform the congestion control for the first streaming data and the second streaming data.

6. The communication device according to claim 2, wherein
the controller is further configured to:
when the first communication rate of the first communication line is equal to or higher than a first threshold, allocate both the first streaming data and the second streaming data to the first communication line;
when the first communication rate of the first communication line is lower than the first threshold and is equal to or higher than a second threshold, allocate both the first streaming data and the second streaming data to the first communication line and perform congestion control for the second streaming data without performing the congestion control for the first streaming data; and
when the first communication rate of the first communication line is lower than the second threshold and is equal to or higher than a third threshold, allocate both the first streaming data and the second streaming data to the first communication line and perform the congestion control for the first streaming data and the second streaming data.

7. The communication device according to claim 6, wherein
the controller is further configured to:
when the first communication rate of the first communication line is lower than the third threshold and is equal to or higher than a fourth threshold, allocate the first streaming data to the first communication line and allocate the second streaming data to the second communication line; and
when the first communication rate of the first communication line is lower than the fourth threshold, allocate both the first streaming data and the second streaming data to the second communication line.

8. The communication device according to claim 6, wherein
the controller is further configured to:
when the first communication rate of the first communication line is lower than the third threshold and is equal to or higher than a fourth threshold, allocate the first streaming data to the second communication line and allocate the second streaming data to the first communication line; and
when the first communication rate of the first communication line is lower than the fourth threshold, allocate both the first streaming data and the second streaming data to the second communication line.

9. The communication device according to claim 7, wherein
when the first communication rate of the first communication line is lower than the fourth threshold, the controller is further configured to control qualities of the first streaming data and the second streaming data based on a second communication rate being a communication rate of the second communication line.

10. The communication device according to claim 9, wherein
the controller is further configured to:
when the second communication rate of the second communication line is equal to or higher than a fifth threshold, not perform congestion control for the first streaming data and the second streaming data;
when the second communication rate of the second communication line is lower than the fifth threshold and is equal to or higher than a sixth threshold, perform the congestion control for the second streaming data without performing the congestion control for the first streaming data; and
when the second communication rate of the second communication line is lower than the sixth threshold and is equal to or higher than a seventh threshold, perform the congestion control for the first streaming data and the second streaming data.

11. The communication device according to claim 1, wherein
policy information indicates a policy of setting the allocation relationship according to a priority of the plurality of streaming data, the priority of the plurality of communication lines, and the first communication rate of the first communication line, and
the controller dynamically controls the allocation relationship based on the policy information.

12. The communication device according to claim 1, wherein
the priority of the plurality of communication lines is preset based on a communication cost, and
the communication cost of the first communication line having a higher priority is lower than the communication cost of the second communication line having a lower priority.

13. A communication method from a moving body to an external device, wherein the moving body is capable of communicating with the external device via a plurality of communication lines,
the communication method comprising:
a process of acquiring a plurality of streaming data to be transmitted to the external device; and
a dynamic allocation control process that dynamically controls an allocation relationship between the plurality of streaming data and the plurality of communication lines, wherein
the plurality of communication lines include:
a first communication line; and
a second communication line having a lower priority than the first communication line, and
the dynamic allocation control process dynamically controls the allocation relationship based on a first communication rate being a communication rate of the first communication line while preferentially allocating the plurality of streaming data to the first communication line in preference to the second communication line.

14. A non-transitory computer-readable recording medium on which a communication program applied to a communication device installed on a moving body is recorded, wherein the moving body is capable of communicating with an external device via a plurality of communication lines,
the communication program being configure to, when executed by a computer, cause the computer to execute:
a process of acquiring a plurality of streaming data to be transmitted to the external device; and
a dynamic allocation control process that dynamically controls an allocation relationship between the plurality of streaming data and the plurality of communication lines, wherein
the plurality of communication lines include:
a first communication line; and
a second communication line having a lower priority than the first communication line, and
the dynamic allocation control process dynamically controls the allocation relationship based on a first communication rate being a communication rate of the first communication line while preferentially allocating the plurality of streaming data to the first communication line in preference to the second communication line.
